(19) United States
(12) Patent Application Publication
(10) Pub. No.: US 2007/0192175 A1
(43) Pub. Date: Aug. 16, 2007

(54) SYSTEM AND METHOD FOR DELIBERATING A PROPOSAL

(75) Inventors: CHUNG-I LEE, Tu-Cheng (TW); Hai-Hong Lin, Shenzhen (CN); De-Yi Xie, Shenzhen (CN); Chen-Chen Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,717

(22) Filed: Sep. 15, 2006

(30) Foreign Application Priority Data
Feb. 11, 2006 (CN) 200610033588.6

(51) Int. Cl. G07C 13/00

(52) U.S. Cl. 705/12

(57) ABSTRACT

A system for deliberating a proposal according to a preferred embodiment is provided. The system includes: a database server for storing data on the proposal to be decided; an application server for obtaining and analyzing the data on the proposal in the database server, extracting outlines of the proposal, informing corresponding attendees to attend a remote conference for deliberating the proposal, collecting opinions from all the attendees, and determining whether the proposal passes the deliberating based on the opinions; and a plurality of client computers distributed in different zones and connected to the application server through a network for providing each attendee with an interface to evaluate the proposal, transmitting information between the application server and the client computers. A related method is also disclosed.

### FIELD OF THE INVENTION

The present invention relates to a system and method for deliberating a proposal.

### DESCRIPTION OF RELATED ART

proposals offer a plan to fill a need, that may be related to a business or a management mechanism, or even a technique reform, or production costs of an enterprise, and so on. Every proposal may be advantageous or disadvantageous to the enterprise, if the disadvantageous risk is too high, or if the disadvantages outweigh the advantages, the proposal may be rejected. Therefore, before a proposal is put in practice, the proposal should be estimated and decided.

A traditional and common procedure to evaluate the proposal is to hold a face-to-face meeting attended by authoritative members of the enterprise, that may includes high-level directors, technologists, financial budget accountants, etc., each member then presents an opinion if necessary regarding the proposal, discusses and collaborates whether the proposal is beneficial amongst themselves.

One drawback of the above manner, is that organizing the face-to-face meeting wastes manpower and material resources, firstly, a meeting room must be booked, then, arrange the meeting room, prepare materials for use, after the meeting, the meeting room has to be cleaned up and returned, this procedure is also time-consuming and boring.

Furthermore, due to a geographical distribution of the enterprise, some members may be at one location at a given time while at a second location at another given time, and some members may be on a business trip, making it difficult for all related members to attend the face-to-face meeting.

Additionally, it's also difficult to schedule the time of the face-to-face meeting.

What is needed, therefore, is a system and method for deliberating the proposal online, so as to decrease manpower and material resources cost and improve efficiency.

### SUMMARY OF THE INVENTION

A system for deliberating a proposal according to a preferred embodiment is provided. The system includes: a database server for storing data on the proposal to be decided; and an application server for obtaining and analyzing the data on the proposal in the database server, extracting outlines of the proposal, informing corresponding attendees to attend a remote conference for deliberating the proposal, collecting opinions from all the attendees online, and determining whether the proposal passes the deliberating based on the opinions.

Another preferred embodiment provides a method for deliberating a proposal. The method includes the steps of: (a) obtaining data on the proposal to be decided; (b) analyzing the obtained data to find out outlines of the proposal; (c) setting attendees of a remote conference for deliberating the proposal, and setting a start time and an end time of the remote conference; (d) informing the attendees to attend the remote conference; (e) receiving opinions from the attendees if the start time of the remote conference arrives; (f) collecting and analyzing all the opinions if the end time of the remote conference arrives; (g) determining whether the proposal passes the deliberating; and (h) informing a corresponding person to deal with the proposal, if the proposal passes the deliberating.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 a schematic diagram illustrating a system for deliberating a proposal according to a preferred embodiment;

FIG. 2 is a block diagram illustrating function modules of an application server in FIG. 1; and

FIG. 3 is a flowchart of a preferred method for deliberating a proposal.

### DETAILED DESCRIPTION OF THE PREFERRED EMBODIMENT

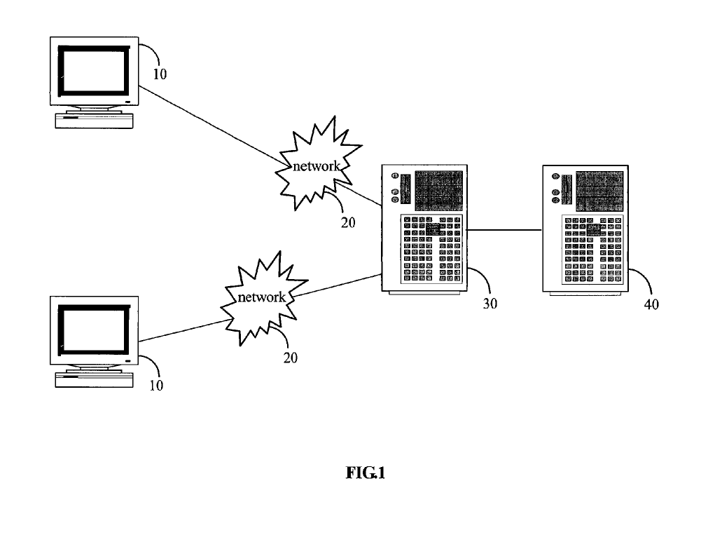

FIG. 1 is a schematic diagram illustrating a system for deliberating a proposal according to a preferred embodiment. The system includes a database server 40, an application server 30, a network 20, and a plurality of client computers 10 (only two shown). The database server 40 is used for storing data used or generated by the system, such data include personnel information of an enterprise, outlines of the proposal, and so on. The outlines of the proposal include an objective of the proposal, a proposed solution, and a detailed program to implement the solution.

The application server 30 is connected to the database server 40, and is used for obtaining and analyzing data of the proposal in the database server 40, extracting outlines of the proposal, informing attendees to participate a remote conference to deliberate the proposal, collecting opinions from all the attendees, and determining whether the proposal should be implemented.

The client computers 10 are at different locations, and are connected to the application server 30 through the network 20. Each client computer 10 provides a user interface to an attendee, for receiving all kinds of notices about the remote conference and sending opinions of the attendee to the application server 30 through the network 20.

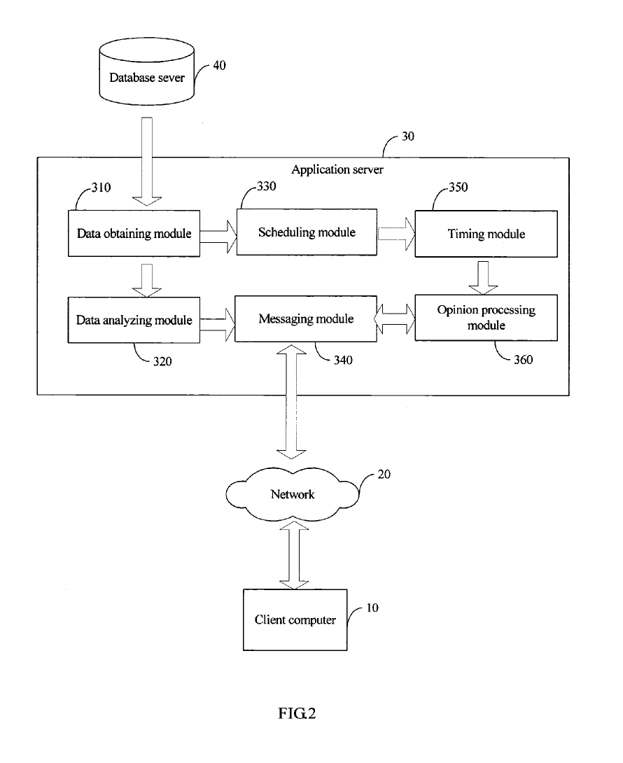

FIG. 2 is a block diagram illustrating function modules of the application server 30. The application server 30 mainly includes: a data obtaining module 310, a data analyzing module 320, a scheduling module 330, a messaging module 340, a timing module 350, and an opinion processing module 360.

The data obtaining module 310 is used for obtaining the data on the proposal from the database server 40. Such data include the outlines of the proposal as mentioned above, and personnel information of the enterprise.

The data analyzing module 320 is used for analyzing the data obtained from the data obtaining module 310 and for extracting the outlines of the proposal. The outlines of the proposal typically include the objective of the proposal, the proposed solution, and the detailed program to implement the solution.

The scheduling module 330 is used for setting parameters of the remote conference for deliberating the proposal. The parameters include: an attendee list, a start time and an end time of the remote conference, regulations of the remote conference that all attendees should follow.

The messaging module 340 is used for sending and receiving messages to-or-from the client computers 10 through the network 20, such as informing the attendees to attend the remote conference, receiving opinions from all the attendees, informing the attendees of the deliberating result at the end of the meeting, and so on.

The timing module 350 is used for controlling the start time and the end of the remote conference. The opinion processing module 360 is used for analyzing the opinions of all the attendees, and determining whether the proposal passes the deliberating according to a predetermined criterion, such as the majority rule.

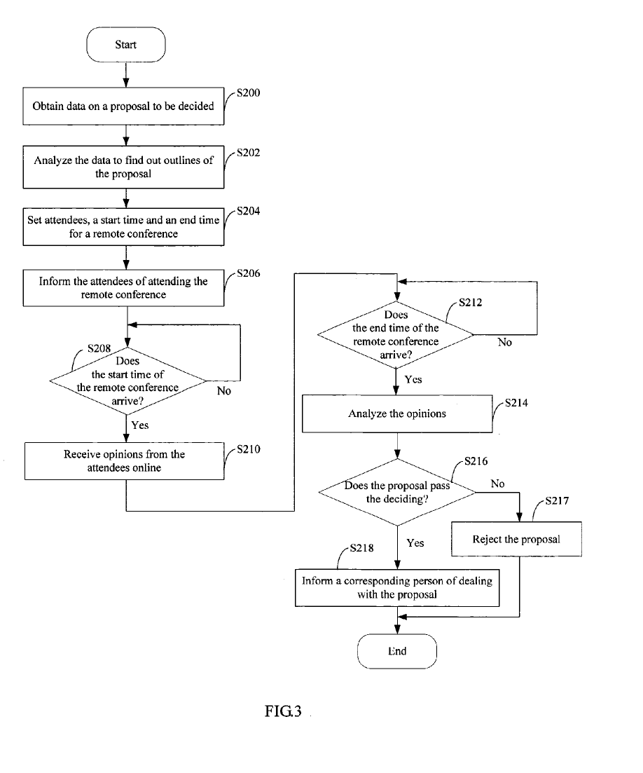

FIG. 3 is a flowchart of a preferred method for deliberating a proposal. In step S200, the data obtaining module 310 obtains data on the proposal from the database server 40, including basic information of the proposal and personnel information of the corresponding enterprise.

In step S202, the data analyzing module 320 analyzes the obtained data for generating outlines of the proposal, such as an objective of the proposal, a proposed solution, and a proposal detailed implementation program, in order to assist attendees of a remote conference in deliberating whether the proposal should be implemented.

In step S204, the scheduling module 330 sets parameters of the remote conference according to the basic information and the personnel information. The parameters include: an attendee list of the proposal; a start time and an end time of the remote conference, such as from “23 Jun. 2004, 09:00:00 AM” to “23 Jun. 2004, 11:00:00 AM”; and regulations of the remote conference. As soon as the parameters are set, the timing module 350 begins to measure time.

In step S206, the messaging module 340 sends a message to each of the attendees. The message may include a notice to inform the attendees to attend the remote conference, the outlines of the proposal, the attendee list and regulations of the remote conference, in order to have the attendee become familiar with the remote conference beforehand.

In step S208, the timing module 350 determines whether the start time of the remote conference arrives. If the start time does not arrive, the timing module continues timing.

If, in step S208, the timing module 350 determines the start time arrives, the remote conference begins. In step S210, each attendee at a client computer 10 presents his opinion regarding the proposal, and the messaging module 340 receives the opinion from the client computer 10.

In step S212, the timing module 350 determines whether the end time of the remote conference arrives. If the end time does not arrive, the timing module 350 continues timing.

If, in step S212, the end time of the remote conference arrives, in step S214, the opinion processing module 360 collects all the opinions from the attendees.

In step S216, the opinion processing module 360 determines whether the proposal passes deliberating according to a predetermined criterion, such as the majority rule. If the proposal passes deliberating, in step S218, the messaging module 340 informs a corresponding person to deal with the proposal.

If, in step S26, the opinion processing module 360 determines the proposal does not pass the deliberating, in step S217, the messaging module 340 rejects the proposal, and sends the deliberating result to a corresponding author of the proposal.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for deliberating a proposal, comprising:
a database server for storing data on the proposal to be decided; and
an application server for obtaining and analyzing the data on the proposal in the database server, extracting outlines of the proposal, informing corresponding attendees to attend a remote conference for deliberating the proposal, collecting opinions from all the attendees online, and determining whether the proposal passes the deliberating based on the opinions.

2. The system as claimed in claim 1, wherein the application server comprises:
a data obtaining module for obtaining the data on the proposal to be decided from the database server;
a data analyzing module for analyzing the obtained data to find out outlines of the proposal;
a scheduling module for setting parameters of the remote conference;
a messaging module for informing the attendees to attend the remote conference; and
an opinion processing module for collecting and analyzing the opinions from all the attendees, and determining whether the proposal passes the deliberating.

3. The system as claimed in claim 2, wherein the parameters comprise: an attendee list, a start time and an end time of the remote conference.

4. The system as claimed in claim 3, wherein the application server further comprises a timing module for controlling the start time and end time of the remote conference.

5. A computer-based method for deliberating a proposal, comprising the steps of:
obtaining data on the proposal to be decided from a database server;
analyzing the obtained data to find out outlines of the proposal;
setting attendees of a remote conference for deliberating the proposal, and setting a start time and an end time of the remote conference;
informing the attendees to attend the remote conference;
receiving opinions from the attendees if the start time of the remote conference arrives;
collecting and analyzing all the opinions if the end time of the remote conference arrives;
determining whether the proposal passes the deliberating; and
informing a corresponding person to deal with the proposal, if the proposal passes the deliberating.

6. The method as claimed in claim 5, wherein the outlines of the proposal comprise: an objective of the proposal, a proposed solution, and a detailed program to implement the solution.

7. The method as claimed in claim 5, further comprising the step of:
continuing timing, if the start time of the remote conference does not arrive.

8. The method as claimed in claim 5, further comprising the step of:
continuing timing, if the end time of the remote conference does not arrive.

9. The method as claimed in claim 5, further comprising the step of:
rejecting the proposal, if the proposal does not pass the deliberating.
